(19) United States
(12) Patent Application Publication
(10) Pub. No.: US 2026/0008266 A1
(43) Pub. Date: Jan. 8, 2026

(54) INKJET RECORDING DEVICE

(71) Applicant: KYOCERA Document Solutions Inc., Osaka (JP)

(72) Inventors: Masato USUI, Osaka (JP); Hiroomi NAKATSUJI, Osaka (JP); Naoko KAWASHIMA, Osaka (JP); Jun NAKANO, Osaka (JP)

(73) Assignee: KYOCERA Document Solutions Inc., Osaka (JP)

(21) Appl. No.: 19/261,525

(22) Filed: Jul. 7, 2025

(30) Foreign Application Priority Data
Jul. 8, 2024 (JP) 2024-109723

(51) Int. Cl. B41J 2/045; B41J 2/21

(52) U.S. Cl. CPC B41J 2/04508; B41J 2/0451; B41J 2/04593; B41J 2/2139; B41J 2/04586

(57) ABSTRACT

In an inkjet recording device, when a defective nozzle in a recording head is corrected, a control unit increases the amount of ink discharged to a correction pixel region adjacent to a defective pixel region corresponding to the defective nozzle in an intersection direction as compared with the amount of ink discharged to each of other pixel regions. The control unit reduces the amount of ink discharged to the correction pixel region by the recording head arranged on a downstream side in the direction of movement of a recording medium as compared with the amount of ink discharged to the correction pixel region by the recording head arranged on an upstream side in the direction of movement of the recording medium.

### INCORPORATION BY REFERENCE

This application is based upon and claims the benefit of priority from the corresponding Japanese Patent Application No. 2024-109723 (filed on Jul. 8, 2024), the entire contents of which are incorporated herein by reference.

### BACKGROUND

The present disclosure relates to inkjet recording devices.

A conventional inkjet recording device includes a recording head, a driving unit, a drying unit and a control unit. The recording head discharges an ink onto a recording medium. The driving unit moves the recording medium relative to the recording head. The drying unit is arranged on a downstream side relative to the recording head in the direction of movement of the recording medium to dry the recording medium. The control unit controls the recording head, the driving unit and the drying unit to perform recording on the recording medium. A plurality of recording heads are arranged in the direction of movement of the recording medium. Each of the recording heads includes a plurality of nozzles which are arranged along an intersection direction intersecting the direction of movement of the recording head relative to the recording medium and discharge ink droplets at different timings.

When a defective nozzle in the recording head is corrected, the control unit reduces the amount of ink discharged to an adjacent pixel region which is adjacent to a correction pixel region in the intersection direction, and the correction pixel region is adjacent in the intersection direction to a defective pixel region to which the defective nozzle is to discharge the ink droplets.

In this way, when the discharge of the ink to the correction pixel region is performed after the discharge of the ink to the adjacent pixel region, it is possible to reduce the movement of the ink droplets discharged to the correction pixel region to the side of the ink droplets in the adjacent pixel region due to droplet settling interference. Hence, it is possible to suppress the occurrence of white streaks in the defective pixel region.

However, in the conventional inkjet recording device, the ink droplets discharged to the correction pixel region are affected by the droplet settling interference until being dried so as to be gradually moved to the side of the ink droplets in the adjacent pixel region. Since the ink droplets discharged from the recording head on the downstream side in the direction of movement of the recording medium reach the drying unit in a shorter time than the ink droplets discharged from the recording head on the upstream side in the direction of movement of the recording medium, the ink droplets discharged from the recording head on the downstream side in the direction of movement of the recording medium are unlikely to be affected by the droplet settling interference. Hence, the amount of movement of the ink droplets discharged from the recording head on the downstream side in the direction of movement of the recording medium to the correction pixel region is reduced, and thus color streaks may occur in the correction pixel region. Therefore, an image quality may be decreased due to the correction of the defective nozzle.

In view of the foregoing, an object of the present disclosure is to provide an inkjet recording device which can suppress a decrease in image quality.

### SUMMARY

An inkjet recording device according to an aspect of the present disclosure includes a recording head, a driving unit, a drying unit and a control unit. The recording head discharges an ink onto a recording medium. The driving unit moves the recording medium relative to the recording head. The drying unit is arranged on a downstream side relative to the recording head in a direction of movement of the recording medium to dry the recording medium. The control unit controls the recording head, the driving unit and the drying unit to record, on the recording medium, an image pattern that has been input. A plurality of recording heads each being the recording head are arranged in the direction of movement of the recording medium. Each of the plurality of recording heads includes a plurality of nozzles that are arranged along an intersection direction intersecting the direction of movement of the recording medium, and that discharge ink droplets at different timings. When a defective nozzle in the recording head is corrected, the control unit increases an amount of the ink discharged to a correction pixel region adjacent to a defective pixel region corresponding to the defective nozzle in the intersection direction as compared with an amount of the ink discharged to each of other pixel regions. The control unit reduces the amount of the ink discharged to the correction pixel region by the recording head arranged on the downstream side in the direction of movement of the recording medium as compared with the amount of the ink discharged to the correction pixel region by the recording head arranged on an upstream side in the direction of movement of the recording medium.

Further objects of the present disclosure and specific advantages obtained by the present disclosure will become clearer from the following description of an embodiment.

### BRIEF DESCRIPTION OF THE DRAWINGS

FIG. 1 is a cross-sectional view showing a schematic configuration of an inkjet recording device 1 according to an embodiment of the present disclosure;

FIG. 2 is a plan view of a recording unit 5 in the inkjet recording device 1 shown in FIG. 1;

FIG. 3 is a block diagram showing a schematic configuration of the inkjet recording device 1.

FIG. 4 is an illustrative view showing ink discharge positions in the inkjet recording device 1 according to the embodiment of the present disclosure;

FIG. 5 is an illustrative view showing ink droplet positions on the plane of a sheet in the inkjet recording device 1 according to the embodiment of the present disclosure;

FIG. 6 is a flowchart showing an example of performance of a correction mode in the inkjet recording device 100 according to the embodiment of the present disclosure; and

FIG. 7 is a table in which the results of evaluations in Example 1 are summarized.

### DETAILED DESCRIPTION

### <1. Configuration of Inkjet Recording Device>

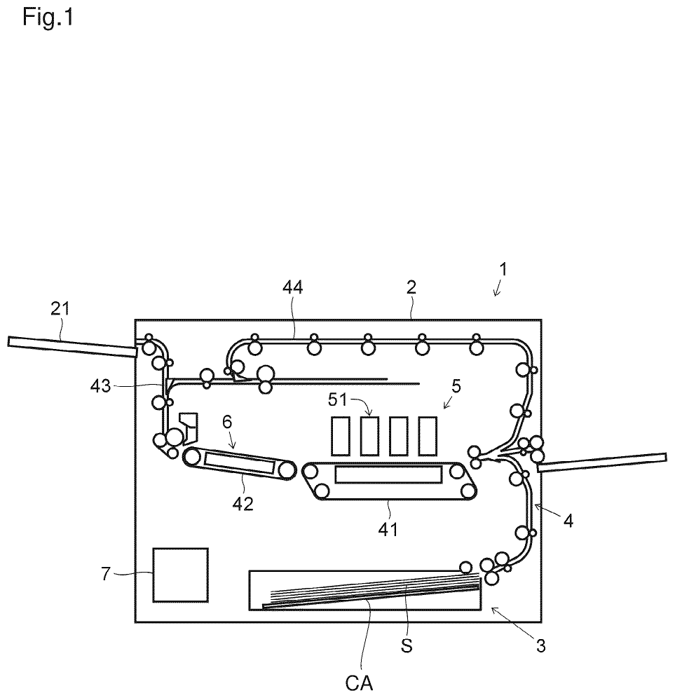

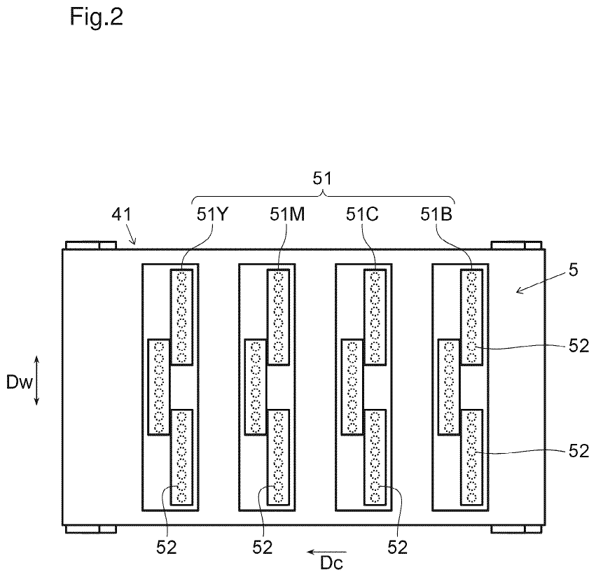

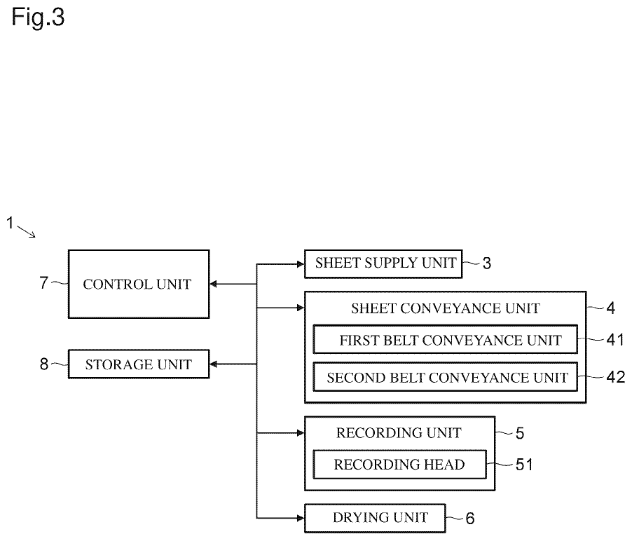

An embodiment of the present disclosure will be described below with reference to drawings. FIG. 1 is a cross-sectional view showing a schematic configuration of the inkjet recording device 1 according to the embodiment. FIG. 2 is a plan view of a recording unit 5 in the inkjet recording device 1 shown in FIG. 1. FIG. 3 is a block diagram showing a schematic configuration of the inkjet recording device 1 shown in FIG. 1. The right side of FIG. 2 is an upstream side in a sheet conveyance direction Dc, and the left side is a downstream side in the sheet conveyance direction Dc. The inkjet recording device 1 is, for example, an inkjet recording printer. As shown in FIGS. 1 to 3, the inkjet recording device 1 includes a device main body 2, a sheet supply unit 3, a sheet conveyance unit 4, the recording unit 5, a drying unit 6 and a control unit 7.

The sheet supply unit 3 stores a plurality of sheets (recording media) S, and separates and feeds the sheets S one by one at the time of image formation. The sheet conveyance unit 4 conveys the sheet S fed from the sheet supply unit 3 to the recording unit 5 and the drying unit 6, and further ejects the sheet S after the image formation and the drying to a sheet ejection unit 21. When double-sided recording is performed, after the completion of the image formation on the first side, the sheet conveyance unit 4 uses a branch unit 43 to direct the dried sheet S to a reverse conveyance unit 44, switches the conveyance direction to reverse the front and back sides and conveys the sheet S again to the recording unit 5 and the drying unit 6.

The sheet conveyance unit 4 includes a first belt conveyance unit 41 and a second belt conveyance unit 42. Each of the first belt conveyance unit 41 and the second belt conveyance unit 42 sucks and retains the sheet S on the upper surface of a seamless belt to convey the sheet S. In other words, the sheet conveyance unit 4 is a driving unit which moves the sheet (recording medium) S relative to the recording unit 5.

The recording unit 5 is opposite the sheet S sucked and retained on the upper surface of the first belt conveyance unit 41 and conveyed, and is arranged above the first belt conveyance unit 41 with a predetermined distance provided therebetween. The recording unit 5 includes line-type inkjet recording heads 51. As shown in FIG. 2, the recording heads 51 include recording heads 51B, 51C, 51M and 51Y corresponding to the four colors of black, cyan, magenta and yellow. A plurality of recording heads 51 of the individual colors are arranged in the sheet conveyance direction Dc. The recording heads 51 of each of the colors, that is, a plurality of (for example, three) recording heads 51 are arranged in a staggered configuration along a sheet width direction Dw orthogonal to the sheet conveyance direction Dc.

Although in the present embodiment, the recording heads 51 of each of the colors, that is, the three recording heads 51 are arranged, the present disclosure is not limited to this configuration. For example, one recording head 51 of each of the colors or four or more recording heads 51 of each of the colors may be arranged.

A plurality of nozzles 52 can discharge the ink droplets over the entire recording region on the sheet S. Specifically, the recording head 51 includes the nozzles 52 which discharge the ink droplets at different timings. The nozzles 52 are arranged along the intersection direction (sheet width direction) Dw which intersects the direction (sheet conveyance direction) Dc of movement of the sheet (recording medium) S.

The recording unit 5 sequentially discharges the inks from the recording heads 51B, 51C, 51M and 51Y of the four colors toward the sheet S conveyed by the first belt conveyance unit 41 to record a full color image or a monochrome image on the sheet S. The recording heads 51B, 51C, 51M and 51Y are sequentially arranged side by side from the upstream side to the downstream side in the sheet conveyance direction Dc.

The drying unit 6 is arranged on the downstream side of the recording unit 5 in the sheet conveyance direction, and the second belt conveyance unit 42 is provided. While the sheet S on which ink images are recorded in the recording unit 5 is being sucked, retained and conveyed by the second belt conveyance unit 42 in the drying unit 6, the inks are dried. In other words, the drying unit 6 is arranged on the downstream side relative to the recording heads 51 in the direction (sheet conveyance direction) Dc of movement of the sheet (recording medium) S to dry the sheet S.

The control unit 7 includes a CPU, other electronic circuits and electric components which are not shown. The CPU controls the operations of constituent elements provided in the inkjet recording device 1 based on control programs and data stored in a storage unit 8 to perform processing related to the functions of the inkjet recording device 1. The sheet supply unit 3, the sheet conveyance unit 4, the recording unit 5 and the drying unit 6 individually receive commands from the control unit 7 to perform recording on the sheet S in conjunction with each other.

The storage unit 8 is configured, for example, by combining nonvolatile storage devices such as a program ROM (Read Only Memory) and a data ROM which are not shown and volatile storage devices such as a RAM (Random Access Memory).

The control unit 7 controls the relative movement of the sheet S and the recording heads 51 to perform recording on the sheet S. More specifically, the control unit 7 controls the recording heads 51 to cause each of the nozzles 52 to discharge an amount of ink corresponding to the pixel value of image data to the sheet S. In this way, an image is formed on the sheet S. In the present embodiment, the direction of movement of the recording heads 51 relative to the sheet S is the sheet conveyance direction Dc.

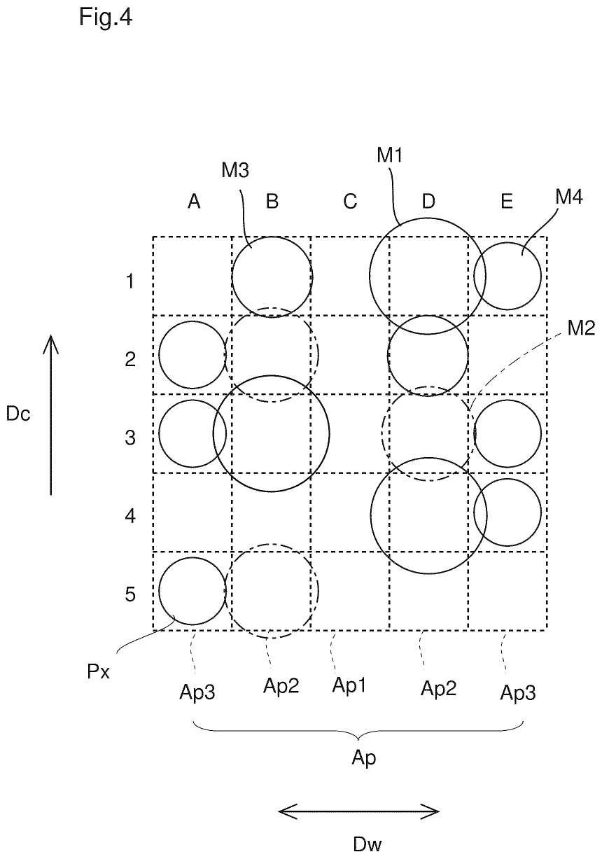

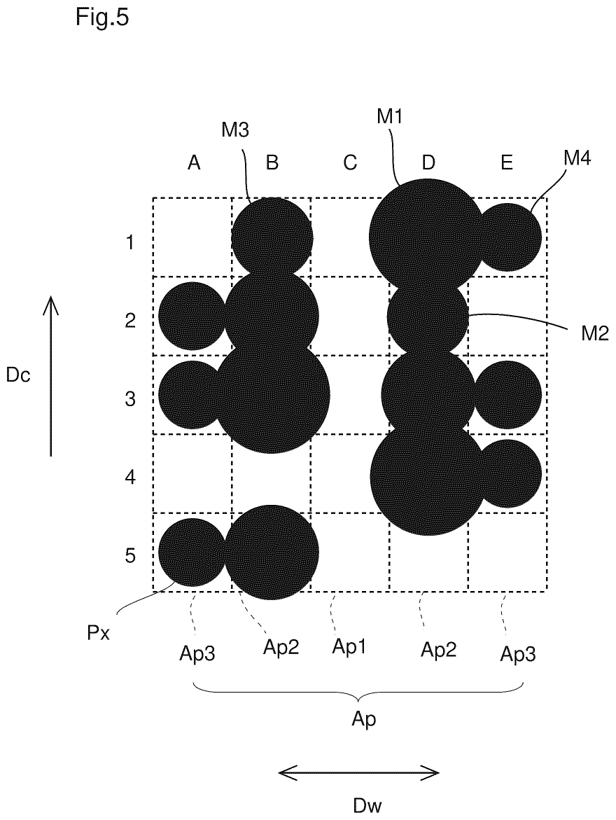

FIG. 4 is an illustrative view showing ink discharge positions, and FIG. 5 is an illustrative view showing ink droplet positions on the plane of the sheet. Specifically, FIGS. 4 and 5 show the ink discharge positions when 14 pixels Px are recorded in 25 pixel regions Ap ranging from the pixel region in the first row and an A column to the pixel region in the fifth row and an E column. The sheet conveyance direction De is a direction which extends from the bottom to the top of FIGS. 4 and 5, and the lower side of FIGS. 4 and 5 is the upstream side in the sheet conveyance direction Dc, and the upper side is the downstream side in the sheet conveyance direction Dc.

In FIGS. 4 and 5, each of the pixel regions Ap means a virtual region obtained by dividing the image recording region of the sheet S by resolution. In FIGS. 4 and 5, the pixel regions are represented by dashed rectangles, but such dashed rectangles are not actually recorded on the sheet S. The control unit 7 transmits an ink discharge control signal to the recording heads 51 each time the sheet S is moved by a distance corresponding to the resolution along the sheet conveyance direction Dc. In this way, the recording heads 51 discharge the ink toward the pixel regions on the sheet S. The pixel Px is the element of an image recorded by the ink droplets which are discharged according to each image region, and is a constituent element of the smallest unit of an image.

In FIG. 4, ink droplets M1 which are discharged by the recording heads 51B and 51C to the correction pixel regions Ap2 are indicated by solid lines. Ink droplets M2 which are discharged by the recording heads 51M and 51Y to the correction pixel regions Ap2 are indicated by alternate long and short dashed lines.

In the present embodiment, nozzles 52 which discharge the ink onto the A column, the C column and the E column among the pixel regions Ap belong to a first-discharge nozzle group, and nozzles 52 which discharge the ink onto the B column and the D column among the pixel regions Ap belong to a second-discharge nozzle group. The nozzles 52 belonging to the first-discharge nozzle group and the nozzles 52 belonging to the second-discharge nozzle group are alternately arranged in the sheet width direction (intersection direction) Dw.

The nozzles 52 belonging to the first-discharge nozzle group discharge the ink droplets before the nozzles 52 belonging to the second-discharge nozzle group. In other words, the ink droplets are discharged from the nozzles 52 belonging to the first-discharge nozzle group, and then the ink droplets are discharged from the nozzles 52 belonging to the second-discharge nozzle group at a timing when the sheet S is moved between the nozzles 52 belonging to the first-discharge nozzle group and the nozzles 52 belonging to the second-discharge nozzle group.

The recording heads 51B, 51C, 51M and 51Y respectively discharge the ink droplets corresponding to the four colors of black (B), cyan (C), magenta (M) and yellow (Y) from the nozzles 52 onto the sheet S. The sheet S and the recording heads 51 are moved relatively, and thus it is possible to form the image of the ink droplets on the sheet S.

The ink droplets M2 discharged from the recording heads 51M and 51Y arranged on the downstream side in the direction (sheet conveyance direction) De of movement of the sheet (recording medium) S reach the drying unit 6 in a shorter time than the ink droplets M1 discharged from the recording heads 51B and 51C arranged on the upstream side in the direction (sheet conveyance direction) Dc of movement of the sheet (recording medium) S, with the result that the ink droplets M2 discharged from the recording heads 51M and 51Y are unlikely to be affected by droplet settling interference.

In the inkjet recording device 1 according to the present embodiment, when a failure such as non-discharge occurs in the nozzle 52 belonging to the first nozzle group, the control unit 7 changes and corrects the amount of ink of the ink droplets discharged from nozzles 52 around the defective nozzle 52.

Specifically, for example, when a failure such as non-discharge occurs in the nozzle 52 corresponding to a defective pixel region Ap1 in the C column, the control unit 7 changes the amount of ink discharged to the defective pixel region Ap1 in the C column to which the ink droplets are to be discharged and the amount of ink discharged to the correction pixel regions Ap2 in the B column and the D column adjacent in the sheet width direction (intersection direction) Dw. The amount of ink discharged to the correction pixel regions Ap2 in the B column and the D column is changed depending on whether the ink droplets have already been discharged to adjacent pixel regions Ap3 in the A column and the E column. The adjacent pixel regions Ap3 in the A column and the E column are adjacent to sides opposite to the defective pixel region Ap1 in the C column with the correction pixel regions Ap2 in the B column and the D column interposed in the sheet width direction (intersection direction) Dw.

More specifically, the amount of ink discharged to the correction pixel regions Ap2 in the B column and the D column when the ink droplets have already been discharged to the adjacent pixel regions Ap3 in the A column and the E column is larger than the amount of ink discharged to the correction pixel regions Ap2 in the B column and the D column when no ink droplets are discharged to the adjacent pixel regions Ap3 in the A column and the E column.

In the present embodiment, the amount of ink discharged can be changed in a plurality of steps. The amount of ink discharged is determined by the size of the ink droplet (pixel). Specifically, the amount of ink discharged is the largest for the pixel Px recorded by the ink droplet of a large size, and the amount of ink discharged is decreased in the order of a medium size and a small size. There is also a case where as the amount of ink discharged, no ink droplets are provided.

Furthermore, in the present embodiment, the ink droplet of the large size discharged to the correction pixel regions Ap2 can be further changed in two steps of the ink droplet M1 and the ink droplet M2 depending on the change in the amount of ink discharged. Hence, the amount of ink discharged is recorded in the five steps including the case where no ink droplets are discharged. The size of the ink droplet (pixel) is not limited to the four steps, and may be set to, for example, a plurality of steps other than the four steps such as six steps. As the size of the ink droplet is increased, the gradation (density) of the pixel is increased.

The ink discharge positions and the ink droplet sizes for a plurality of pixel regions Ap are determined based on image data to be recorded on the sheet S. In the present embodiment, the ink is discharged to the pixel Px in the second row and the A column, the pixel Px in the third row and the A column, the pixel Px in the fifth row and the A column, the pixel Px in the first row and the B column, the pixel Px in the second row and the B column, the pixel Px in the third row and the B column, the pixel Px in the fifth row and the B column, the pixel Px in the first row and the D column, the pixel Px in the second row and the D column, the pixel Px in the third row and the D column, the pixel Px in the fourth row and the D column, the pixel Px in the first row and the E column, the pixel Px in the third row and the E column and the pixel Px in the fourth row and the E column. The discharge pattern of the ink in the present embodiment is an example, and the present disclosure is not limited to this discharge pattern.

When a failure such as non-discharge occurs in the nozzle 52 corresponding to the defective pixel region Ap1 in the C column, no ink droplets are discharged to the defective pixel region Ap1 in the C column. The ink droplets M1 and M2 of the large size are discharged to the correction pixel regions Ap2 of the second row and the B column, the third row and the B column, the fifth row and the B column, the first row and the D column, the third row and the D column and the fourth row and the D column. The ink droplets M3 of the medium size are discharged to the correction pixel regions Ap2 of the first row and the B column and the second row and the D column. The ink droplets M4 of the medium size are discharged to the adjacent pixel regions Ap3 of the second row and the A column, the third row and the A column, the fifth row and the A column, the first row and the E column, the third row and the E column and the fourth row and the E column.

When the ink is discharged based on the ink discharge positions and the ink droplet sizes for the pixel regions Ap determined as described above (see FIG. 4), the pixels Px are actually recorded in the ink droplet positions on the plane of the sheet shown in FIG. 5.

The pixels Px in the second row and the B column, the third row and the B column, the fifth row and the B column, the first row and the D column, the third row and the D column and the fourth row and the D column are respectively recorded close to the pixels Px in the second row and the A column, the third row and the A column, the fifth row and the A column, the first row and the E column, the third row and the E column and the fourth row and the E column which are adjacent in the sheet width direction Dw. This is caused by the fact that the ink droplets in the correction pixel regions Ap2 are attracted by the droplet settling interference to the ink droplets in the adjacent pixel regions Ap3 discharged previously on the sheet S.

On the other hand, the pixels Px in the first row and the B column and the second row and the D column are respectively recorded not to be close to the adjacent pixel regions Ap3 of the first row and the A column and the second row and the E column which are adjacent in the sheet width direction Dw. In other words, the ink droplets in the correction pixel regions Ap2 are unlikely to be attracted to the adjacent pixel regions Ap3 to which no ink droplets are discharged.

In the present embodiment, the amount of ink discharged later to the correction pixel regions Ap2 of the B column and the D column is changed depending on whether the ink droplets have already been discharged to the adjacent pixel regions Ap3 of the A column and the B column.

Specifically, the ink droplets M1 and M2 of the large size are discharged to the correction pixel regions Ap2 of the second row and the B column, the third row and the B column, the fifth row and the B column, the first row and the D column, the third row and the D column and the fourth row and the D column. On the other hand, the ink droplets M3 of the medium size are discharged to the correction pixel regions Ap2 of the first row and the B column and the second row and the D column.

In other words, the amount of ink discharged to the correction pixel regions Ap2 is different from the amount of ink discharged to the adjacent pixel regions Ap3. The amount of ink discharged to the correction pixel regions Ap2 when the ink droplets have already been discharged to the adjacent pixel regions Ap3 adjacent in the intersection direction Dw is two or three steps higher than the amount of ink discharged to the adjacent pixel regions Ap3, and the amount of ink discharged to the correction pixel regions Ap2 when no ink droplets are discharged to the adjacent pixel regions Ap3 adjacent in the intersection direction Dw is one step higher than the amount of ink discharged to the adjacent pixel regions Ap3.

In this way, the ink droplets M1 and M2 of the large size are discharged to the correction pixel regions Ap2 which are easily affected by the droplet settling interference, and thus even when the ink droplets are moved to the side of the adjacent pixel regions Ap3, the pixels Px having a large diameter are recorded due to the ink droplets of the large size. In this way, a part of the pixels Px are extended out of the correction pixel regions Ap2 to cover a part of the defective pixel region Ap1. Hence, it is possible to reduce the occurrence of white streaks in the defective pixel region Ap1.

On the other hand, the ink droplets of the medium size are discharged to the correction pixel regions Ap2 which are easily affected by the droplet settling interference, and thus it is possible to reduce the occurrence of black streaks (color streaks) in the correction pixel regions Ap2. It is also possible to suppress the amount of ink consumed.

The ink discharged from the recording heads 51M and 51Y arranged on the downstream side in the direction (sheet conveyance direction) Dc of movement of the sheet (recording medium) S reaches the drying unit 6 in a shorter time than the ink discharged from the recording heads 51B and 51C arranged on the upstream side in the direction (sheet conveyance direction) Dc of movement of the sheet (recording medium) S, with the result that the ink discharged from the recording heads 51M and 51Y is unlikely to be affected by the droplet settling interference. In this way, the amount of movement of the ink droplets M2 discharged from the recording heads 51M and 51Y to the correction pixel regions Ap2 is lower than the amount of movement of the ink droplets M1 discharged from the recording heads 51B and 51C to the correction pixel regions Ap2.

Hence, when the amount of ink of the ink droplets M1 discharged is the same as the amount of ink of the ink droplets M2 discharged, and a correction is made to suppress the occurrence of white streaks in the defective pixel region Ap1, white streaks may occur in the correction pixel regions Ap2 to which the ink droplets M2 are discharged from the recording heads 51M and 51Y. Therefore, an image quality may be decreased due to the correction of a defective nozzle.

In the present embodiment, the amount of ink of the ink droplets M2 discharged is lower than the amount of ink of the ink droplets M1 discharged. Hence, the amount of ink discharged to the correction pixel regions Ap2 by the recording heads 51M and 51Y arranged on the downstream side in the direction (sheet conveyance direction) Dc of movement of the sheet (recording medium) S is lower than the amount of ink discharged to the correction pixel regions Ap2 by the recording heads 51B and 51C arranged on the upstream side in the direction (sheet conveyance direction) Dc of movement of the sheet (recording medium) S.

Therefore, the amount of ink discharged to the correction pixel regions Ap2 from the recording heads 51M and 51Y which are not significantly affected by the droplet settling interference is reduced, and thus it is possible to reduce the occurrence of black streaks (color streaks) in the correction pixel regions Ap2.

Although in the present embodiment, the ink droplets M3 of the medium size are discharged to the correction pixel regions Ap2 of the first row and the B column and the second row and the D column, the ink droplets M4 of the small size may be discharged to the correction pixel regions Ap2 of the first row and the B column and the second row and the D column. In other words, only when the ink droplets have already been discharged to the adjacent pixel regions Ap3, the amount of ink discharged to the correction pixel regions Ap2 may be increased as compared with the amount of ink discharged to the other pixel regions. In the correction pixel regions Ap2 in which the ink droplets discharged previously are not present, the amount of ink discharged is not changed. In this way, it is possible to prevent an image failure caused by a change in the amount of ink discharged from occurring in the correction pixel regions Ap2 which are not affected by the droplet settling interference.

An ink discharge pattern to the correction pixel regions Ap2 is different from an ink discharge pattern to the other pixel regions including the adjacent pixel regions Ap3. The ink discharge pattern is, for example, the waveform and gradation of ink discharge. The ink discharge pattern to the correction pixel regions Ap2 is caused to differ from the ink discharge pattern to the other pixel regions such as the adjacent pixel regions Ap3, and thus it is possible to correct a defective nozzle 52 more accurately to suppress a decrease in image quality.

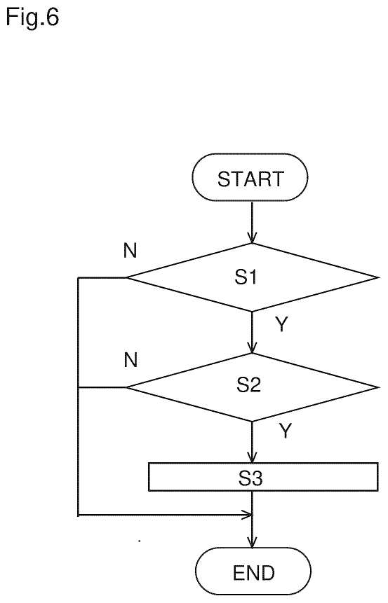

FIG. 6 is a flowchart showing an example of performance of image processing on the inkjet recording device 1. In the present embodiment, a correction mode for correcting the driving conditions of the recording heads 51 when a normal recording mode is performed can be performed. When the correction mode is performed, whether a nozzle 52 in which a failure such as non-discharge has occurred is present is detected (step S1).

Specifically, a check chart (not shown) for detecting the defective nozzle 52 is recorded on the sheet S, and the check chart recorded on the sheet S is optically read with an image reading unit (not shown). Then, recording data corresponding to the read image is generated, and based on the recording data, the defective nozzle 52 is detected. When the defective nozzle 52 is detected (yes in step S1), the defective nozzle 52 is identified and stored in the storage unit 8.

In step S2, whether the identified defective nozzle 52 belongs to the first-discharge nozzle group is determined. When the defective nozzle 52 belongs to the first-discharge nozzle group (yes in step S2), the processing proceeds to step S3.

In step S3, the driving conditions of the recording heads 51 are corrected. In this way, the amount of ink of the ink droplets discharged from the nozzles 52 around the defective nozzle 52 is corrected. The driving conditions of the recording heads 51 which have been corrected are stored in the storage unit 8. Hence, when the normal recording mode is performed, the image is formed based on the driving conditions of the recording heads 51 which have been corrected. Therefore, it is possible to reduce the occurrence of white streaks and black streaks (color streaks) when the recording mode is performed.

When the gradation value of an image pattern recorded when the recording mode is performed is corrected to be equal to or greater than a predetermined value, the control unit 7 preferably sets, to the maximum value, the amount of increase in the amount of the ink discharged to all the correction pixel regions Ap2. In this way, it is possible to more suppress a decrease in image quality.

Then, an evaluation was performed on whether the amount of ink of the ink droplets discharged from the nozzles 52 around the defective nozzle 52 is corrected, and thus it is possible to suppress the occurrence of an image failure.

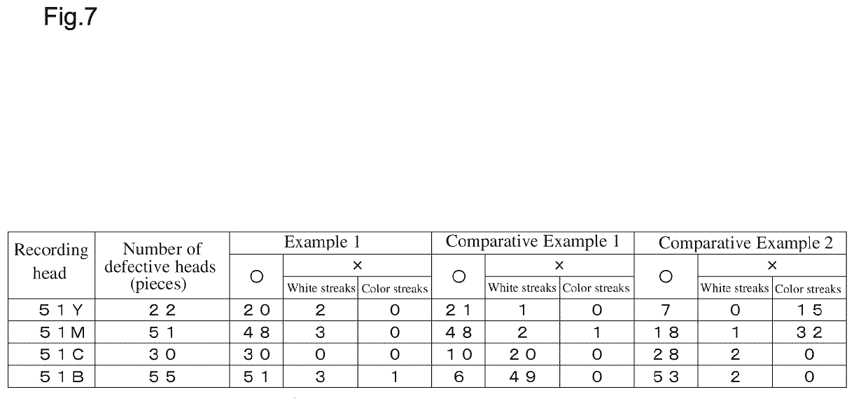

As an evaluation method, in the evaluations of Example 1, Comparative Example 1 and Comparative Example 2, for the defective nozzle 52 belonging to the first-discharge nozzle group, the amount of ink discharged to the correction pixel regions Ap2 by the recording heads 51M and 51Y arranged on the downstream side in the direction (sheet conveyance direction) Dc of movement of the sheet (recording medium) S and the amount of ink discharged to the correction pixel regions Ap2 by the recording heads 51B and 51C arranged on the upstream side in the direction (sheet conveyance direction) Dc of movement of the sheet (recording medium) S were changed. Here, the number of white streaks and the number of color streaks which occurred were counted and summarized in a table shown in FIG. 7.

In the recording head 51B, 55 defective nozzles 52 were present, in the recording head 51C, 30 defective nozzles 52 were present, in the recording head 51M, 51 defective nozzles 52 were present and in the recording head 51Y, 22 defective nozzles 52 were present. These defective nozzles 52 were arranged in all positions where the droplet settling interference occurred. In the evaluations of Example 1, Comparative Example 1 and Comparative Example 2, the ink droplets had already been discharged to the adjacent pixel regions Ap3.

The recording heads 51B, 51C, 51M and 51Y were sequentially arranged from the upstream side to the downstream side in the sheet conveyance direction Dc, the time taken for the ink droplets discharged from the recording head 51B to reach the drying unit 6 was 156. 25 (ms). The time taken for the ink droplets discharged from the recording head 51C to reach the drying unit 6 was 125 (ms). The time taken for the ink droplets discharged from the recording head 51M to reach the drying unit 6 was 93.75 (ms). The time taken for the ink droplets discharged from the recording head 51Y to reach the drying unit 6 was 62.5 (ms).

In the evaluations of Example 1, Comparative Example 1 and Comparative Example 2, the ink droplets M1 or M2 of the large size were discharged to the correction pixel regions Ap2. The amount of ink of the ink droplets M1 discharged was larger than the amount of ink of the ink droplets M2 discharged (see FIG. 4).

In the evaluation of Example 1, the recording heads 51M and 51Y discharged the ink droplets M2 to the correction pixel regions Ap2. The recording heads 51B and 51C discharged the ink droplets M1 to the correction pixel regions Ap2.

In the evaluation of Comparative Example 1, the recording heads 51B, 51C, 51M and 51Y discharged the ink droplets M2 to the correction pixel regions Ap2.

In the evaluation of Comparative Example 2, the recording heads 51B, 51C, 51M and 51Y discharged the ink droplets M1 to the correction pixel regions Ap2.

In the evaluation on whether the occurrence of an image failure can be suppressed, image data was recorded under the driving conditions of each of the recording heads 51, and whether white streaks or color streaks were present in the recorded image data was observed. When no white streaks or color streaks occurred, the evaluation was determined to be satisfactory (indicated by “O”). When white streaks or color streaks occurred, the evaluation was determined to be unsatisfactory (indicated by “x”).

It was found from the table shown in FIG. 7 that in the evaluation of Example 1, the occurrence of white streaks or color streaks caused by the ink droplets discharged from the recording heads 51B, 51C, 51M and 51Y was suppressed, and thus it was possible to reduce the occurrence of an image failure. On the other hand, it was found that in the evaluation of Comparative Example 1, white streaks easily occurred due to the ink droplets discharged from the recording heads 51B and 51C which were significantly affected by the droplet settling interference. It was found that in the evaluation of Comparative Example 2, color streaks easily occurred due to the ink droplets discharged from the recording heads 51M and 51Y which were not significantly affected by the droplet settling interference.

Although the embodiment of the present disclosure has been described above, the scope of the present disclosure is not limited to the embodiment, and various changes can be made without departing from the spirit of the disclosure. For example, for the correction of the defective nozzle 52, in a part of the image pattern, the amount of ink discharged to the correction pixel regions Ap2 by the recording heads 51M and 51Y arranged on the downstream side in the direction (sheet conveyance direction) Dc of movement of the sheet (recording medium) S may be the same as the amount of ink discharged to the correction pixel regions Ap2 by the recording heads 51B and 51C arranged on the upstream side in the direction (sheet conveyance direction) Dc of movement of the sheet (recording medium) S.

Although in the present embodiment, the amount of ink discharged to the correction pixel regions Ap2 by the recording heads 51M and 51Y arranged on the downstream side in the direction (sheet conveyance direction) Dc of movement of the sheet (recording medium) S is lower than the amount of ink discharged to the correction pixel regions Ap2 by the recording heads 51B and 51C arranged on the upstream side in the direction (sheet conveyance direction) Dc of movement of the sheet (recording medium) S, the present disclosure is not limited to this configuration. For example, the amount of ink discharged to the correction pixel regions Ap2 by the recording head 51Y arranged on the downstream side in the direction (sheet conveyance direction) Dc of movement of the sheet (recording medium) S may be lower than the amount of ink discharged to the correction pixel regions Ap2 by the recording heads 51B, 51C, 51M and 51Y arranged on the upstream side in the direction (sheet conveyance direction) De of movement of the sheet (recording medium) S.

The amount of ink discharged to the correction pixel regions Ap2 may be reduced in the order of the recording heads 51B, 51C, 51M and 51Y.

The present disclosure can be utilized in inkjet recording devices.

What is claimed is:

1. An inkjet recording device comprising:
a recording head that discharges an ink onto a recording medium;
a driving unit that moves the recording medium relative to the recording head;
a drying unit that is arranged on a downstream side relative to the recording head in a direction of movement of the recording medium to dry the recording medium; and
a control unit that controls the recording head, the driving unit and the drying unit to record, on the recording medium, an image pattern that has been input,
wherein a plurality of recording heads each being the recording head are arranged in the direction of movement of the recording medium,
each of the plurality of recording heads includes a plurality of nozzles
that are arranged along an intersection direction intersecting the direction of movement of the recording medium, and
that discharge ink droplets at different timings,
when a defective nozzle in the recording head is corrected, the control unit increases an amount of the ink discharged to a correction pixel region adjacent to a defective pixel region corresponding to the defective nozzle in the intersection direction as compared with an amount of the ink discharged to each of other pixel regions and
the control unit reduces the amount of the ink discharged to the correction pixel region by the recording head arranged on the downstream side in the direction of movement of the recording medium as compared with the amount of the ink discharged to the correction pixel region by the recording head arranged on an upstream side in the direction of movement of the recording medium.

2. The inkjet recording device according to claim 1,
wherein when the defective nozzle in the recording head is corrected, only if the ink droplets have already been discharged to an adjacent pixel region that is adjacent to a side opposite to the defective pixel region with the correction pixel region interposed in the intersection direction, the control unit increases the amount of the ink discharged to the correction pixel region as compared with the amount of the ink discharged to each of the other pixel regions.

3. The inkjet recording device according to claim 1,
wherein in a part of the image pattern, the amount of the ink discharged to the correction pixel region by the recording head arranged on the downstream side in the direction of movement of the recording medium is the same as the amount of the ink discharged to the correction pixel region by the recording head arranged on the upstream side in the direction of movement of the recording medium.

4. The inkjet recording device according to claim 2,
wherein an ink discharge pattern to the correction pixel region is different from an ink discharge pattern to each of the other pixel regions.

5. The inkjet recording device according to claim 1,
wherein when a gradation value of the image pattern recorded after the correction is equal to or greater than a predetermined value, the control unit sets, to a maximum value, an amount of increase in an amount of the ink discharged to each of all correction pixel regions each being the correction pixel region.
